(19) United States
(12) Patent Application Publication
(10) Pub. No.: US 2002/0087300 A1
(43) Pub. Date: Jul. 4, 2002

(54) Method of interactive image creation for device emulator

(76) Inventor: Srinivas Patwari, San Diego, CA (US)

Correspondence Address: Qualcomm Incorporated, Patents Department, 5775 Morehouse Drive, San Diego, CA, 92121-1714, US

(21) Appl. No.: 09/755,669

(22) Filed: Jan. 4, 2001

(51) Int. Cl. G06F 9/455

(52) U.S. Cl. 703/22

(57) ABSTRACT

An interactive image of a mobile device, for use by mobile device emulator software, is created by defining interactive areas on the image. The position of an interactive area is defined by a single user actuation, with the shape, size and attributes of the interactive area being set as a default.

### BACKGROUND OF THE INVENTION

The present invention relates to a method of creating an image in an electronic device emulator, particularly a wireless device emulator.

An example of a wireless device emulator is the ‘BREW SDK’ emulation software developed by the assignee of the present application. This software runs on a 32-bit Windows™ (e.g. Windows 95, 98, Me, NT or 2000) platform on a desktop personal computer (PC). The emulation software emulates the operating environment of the wireless device and allows the user to create and modify applets for running in that operating environment on the device. To allow realistic simulation and thereby improve the ergonomics of an applet, an image of the wireless device can be displayed with a simulated output on the screen, and the keys of the image can be actuated. An interactive image of a wireless device is created using a skin configurator application, in which an image of a wireless device is input, and the user then designates different areas of the image as the display and specific keys of the device. Each area is designated as a key or display by clicking a mouse pointer on one corner of the area and dragging it over to the opposite corner, thereby defining a rectangular box. However, this operation is time-consuming, taking 20 to 30 minutes for a typical mobile telephone.

### SUMMARY OF THE INVENTION

According to one aspect of the present invention, there is provided a method of creating an interactive image of a user-operable device on a computer, comprising the steps of:

displaying an image of the device on a display of the computer;

displaying a moveable cursor on the display, the position of the cursor being variable according to input by the user of the computer;

setting an area property; and

defining a plurality of areas of said image, each having said area property, at positions on said image defined by a corresponding plurality of user inputs;

wherein each of said user inputs defines a single position on said image.

Preferably, said area property is a size and/or shape of the area.

Subsequently, the interactive functions of the image are dependent on the defined areas.

### BRIEF DESCRIPTION OF THE DRAWINGS

An embodiment of the present invention will now be described with reference to the accompanying drawings, in which:

FIG. 1 is a screen image of skin configurator software in an embodiment of the invention; and

FIG. 2 is a screen image of device emulator software using a skin configured by the skin configurator software.

### DETAILED DESCRIPTION OF THE PREFERRED EMODIMENT

The skin configurator software in an embodiment of the present invention is based on the Qualcomm™ Skin Configurator (QSC) software already in use by the applicant, with improvements as will now be described.

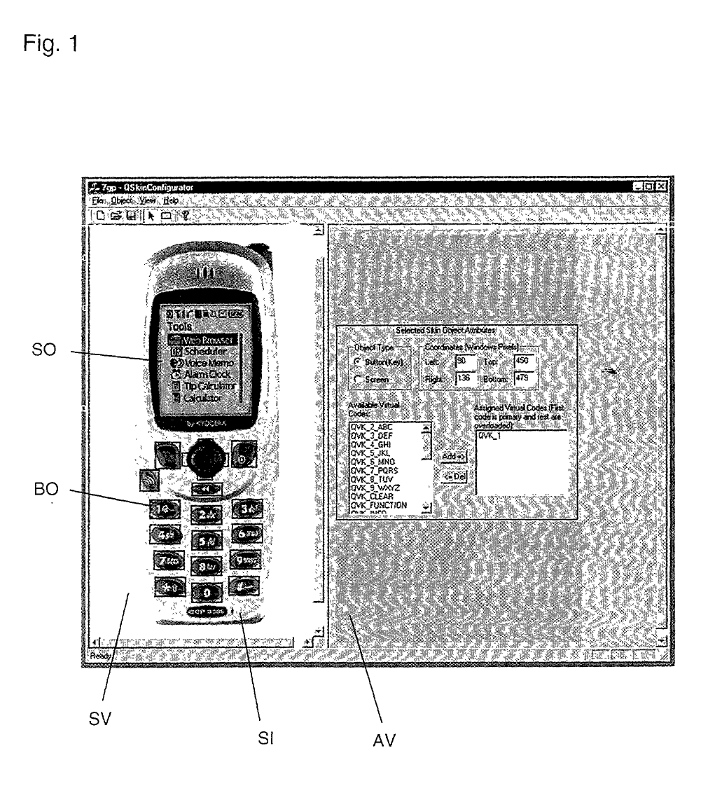

FIG. 1 shows a window display of the skin configurator software, which is divided into a skin view area SV and an attribute view area AV. Within the skin view area SV is a skin image SI, which in this example is an image of a Kyocera™ 7GP QCP-3035 CDMA phone.

Superimposed on each of the interactive areas of the skin image SI is a rectangle defining a skin object, which may either be a screen object SO, or a button object BO. When one of these objects is highlighted, as shown on the ‘1’ key in FIG. 1, the attributes of that skin object are shown in the attribute view area AV.

To create a new skin object in this embodiment, the user positions the mouse pointer at a point on the skin image and clicks a mouse button, such as a Right Mouse button, in response to which a skin object of a previously defined size and shape is created at that point, and its outline is displayed. The software can either be set in centre mode, in which the point at which the user clicks is set as the centre of the skin object, or a corner mode in which the point is set as a corner, such as the top left hand corner of the skin object. The properties, such as size and shape, of the skin object are set to be the same as the previously created skin object, or as a user configurable default size and shape. The user may configure the default size and shape by selecting from a number of possible shapes, such as circle, ellipse or rectangle, and by defining a width and height of the object by means of the user interface.

This technique is particularly advantageous because groups of similar objects, such as numeric keys, tend to be of the same size and shape. Hence, the user need only define these properties for one of the group and can then rapidly define similar objects using only one mouse click per object. In this way, the skin shown in FIG. 1 can easily be configured in 3 to 5 minutes.

Although a mouse is described as the input device in this example, a skin object may equally be positioned and created using other user input devices, such as a keyboard, a graphics tablet, a touch-sensitive pad or a touch sensitive screen. For example, only one tap of a touch-sensitive screen would be needed to create a new object at the tapped point. Alternatively, the user may position the pointer and then press a key selected according to the desired property of the object; for example, pressing the ‘1’ key on the keyboard creates an object at the pointer having the attribute of the numerical ‘1’ key on the device.

Other object properties can be set within the attribute view AV, either as the object is created, or subsequently when the object is selected.

The individual skin objects are preferably created as new objects, rather than being defined as copies of other objects, thereby avoiding cascading of newly created objects so that no link information is created between objects.

Once all of the desired skin objects have been configured, the configuration information is saved in a resource file, which is read and interpreted by emulator software to provide an interactive emulation of the device.

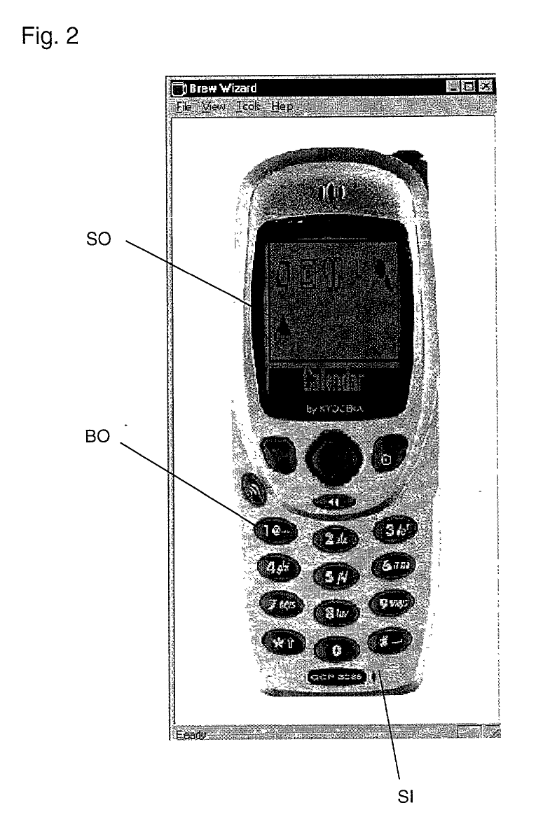

As shown in FIG. 2, the emulator software displays the configured skin image SI and responds to the mouse pointer being clicked within an area defined as a button object BO according to the attributes defined for that object. In this way, the pressing of buttons on the device is emulated to provide input to the applet running on the emulator software, which provides an output for display on the screen object SO.

Although the specific embodiment has been described with reference to a skin configurator for a mobile telephone emulator, the present invention is also applicable to configuration of emulators for other user-operable devices, particularly those having groups of identical buttons or other interactive features.

What is claimed is:

1. A method of defining an interactive area of an image of a user-operable device on a computer, comprising the steps of:
displaying an image of the device on a display of the computer;
displaying a moveable cursor on the display, the position of the cursor being variable according to input by the user of the computer; and
defining an interactive area at a position on said image determined by a user input;
wherein said user input defines a single position on said image.

2. A method according to claim 1, including setting a property of said interactive area.

3. A method according to claim 2, wherein said property is a size and/or shape of the interactive area.

4. A method according to claim 2, wherein said property is set according to a previous property of a previously created interactive area.

5. A method according to claim 1, further comprising setting an attribute of said interactive area.

6. A method according to claim 5, further comprising receiving an input in response to user actuation within said interactive area, the input being dependent on said attribute of said interactive area.

7. A method of defining an interactive area of an image of a user-operable device on a computer, comprising the steps of:
displaying an image of the device on a display of the computer;
displaying a moveable cursor on the display, the position of the cursor being variable according to input by a user of the computer; and
defining an interactive area at a position on said image determined by a user input;
wherein said user input comprises a single user actuation.

8. A computer program arranged to perform a method according to claim 1, when executed on a suitably arranged computer.

9. A computer program carrier carrying a computer program according to claim 8.
